(19) United States
(12) Patent Application Publication
(10) Pub. No.: US 2005/0090013 A1
(43) Pub. Date: Apr. 28, 2005

(54) Separation channel with transverse pump extraction

(76) Inventors: Joel Myerson, Berkeley, CA (US); Magdalena Bynum, San Jose, CA (US); Bill James Peck, Mountain View, CA (US); David L. Hirschberg, Menlo Park, CA (US); Viorica Lopez-Avila, Cupertino, CA (US); Dan-Hui Dorothy Yang, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/695,316

(22) Filed: Oct. 28, 2003

(51) Int. Cl. G01N 30/02

(52) U.S. Cl. 436/161; 422/58

(57) ABSTRACT

A multi-dimensional chemical-analysis system includes a longitudinally extending iso-electric focusing (IEF) channel and transversely extending high-pressure liquid chromatography (HPLC) channels. Piezo-electric pumps force sample fluid from the IEF channel to form jets as it exits through respective pump nozzles. The jets then enter the HPLC channels for parallel second-dimension separations. Alternatively, the jets can be used to “print” sample onto a moving medium to provide a two-dimensional time-vs.-band-position distribution of sample components.

### BACKGROUND OF THE INVENTION

The present invention relates to analytical chemistry and, more particularly, to sample-component separation. A major objective of the invention is to increase throughput where two-dimensional separations are required.

Much of modern progress in the environmental, life, and medical sciences are associated with advances in analytical chemistry. These advances include methods of separating components of a sample so that they can be detected, identified, and quantified independently. Many of these methods, including various types of chromatography and electrophoresis, separate components by causing them to migrate along a separation path at different rates according to the respective component properties. Other methods, such as isoelectric focusing (IEF), move components to respective positions along a separation path according to the respective component properties, such as isoelectric point.

All of the foregoing separation methods separate components as a function of respective values of a separation parameter. For example, electrophoresis separates components according to charge-to-electrophoretic drag ratio. If the charge-to-drag ratios of two components are close, they may not be completely separated by electrophoresis. Likewise, isoelectric focusing cannot separate components with similar isoelectric points, and chromatography cannot separate components with similar partitioning constants. Instead of producing discrete component peaks, a separation technique can result in superimposed or overlapping peaks.

Typically, groups of components are eluted from a first separation path so that they can be introduced into a second separation path, representing the second dimension for separation. For methods that separate components by migration rate, it can be time consuming for the components that migrate most slowly to elute from the first path. This limits the throughput for the two-dimensional separation. For position-based methods, like isoelectric focusing, there is the challenge of eluting components in a manner that preserves the peaks. One approach is to gradually shift the pH gradient, which can also be time consuming and, thus, limit throughput.

U.S. Pat. No. 6,013,165 (20000111) to Wiktorowicz et al. discloses two-dimensional electrophoresis in a system with transverse ports along a first separation channel. After sample components are separated along the first separation channel using a longitudinal electric field, transverse electric fields are applied to separate components along a transverse channel. Piezoelectric pumping is mentioned as a possible means of sample collection from the selected sample lanes. WO 0214851 (20020221) to Wiktorowicz et al. discloses a similar apparatus with possible piezoelectric pumping in which the channels comprising the second dimension are filled with a solid support. The support is activated in order to capture specific bands of the separation, and moved for later analysis.

The methods disclosed by Wiktorowicz are limited to electrophoresis and to transfer speeds associated with electrophoresis. However, this approach is limited to using two dimensions of electrophoresis, whereas, other types of two-dimensional separation are desirable or required as well.

Two approaches currently used for the fractionation of proteins using IEF that are suitable for transferring to a second, non-electrophoretic dimension, are: a) the Rotofor cell (BioRad, Hercules, Calif.) and b) free solution IEF. In the Rotofor cell, soluble carrier ampholytes create a gradient across the focusing chambers. Since the sample volume requirements are quite high (e.g., 18 mL or higher) this becomes a serious issue for many biological applications where sample size is limited. Furthermore, the resulting fractions may contain carrier ampholytes which can impair subsequent separation of the fractions. The second approach uses free-solution IEF and isoelectric membranes developed by Righetti et al. (Analytical Chemistry 2001, 73, 320A-326A). A multicomponent electrolyzer with a single chamber volume of 500 μL was built and by proper selection of pH ranges major components such as albumin could be removed. A multichamber IEF device (96 chambers, 75 μL each, arranged in 8 rows) was reported by Tan et al (Electrophoresis, 2002, 23, 3599-3607) in which the separated components were removed using a multichannel pipette. What is needed is a more flexible and higher speed approach to multi-dimensional chemical analysis.

### SUMMARY OF THE INVENTION

The present invention provides a chemical-analysis system with a longitudinally-extending separation channel and pump for extracting sample fluid transversely from longitudinally separated locations along the channel and expelling the extracted fluid. For example, piezo-electric pumps can be used to extract sample fluid from an iso-electric focusing channel and to expel the fluid in the form of jets.

The chemical-analysis system can include parallel secondary separation columns that further separate components in the expelled fluid. Alternatively, the chemical-analysis system can include means for moving a collection medium relative to the pumps to provide a two-dimensional time-vs-channel-location distribution of sample components.

The invention also provides a chemical-analysis method in which sample components are separated along a longitudinally extending primary separation channel and then pumped concurrently from discrete locations along the channel. The invention provides for jetting sample fluid from discrete longitudinal positions along the separation channel much as an inkjet printer transfers ink from a cartridge. Selective activation of drive elements, e.g., piezo-electric drivers or resistive thermal, allows some component elements to be ejected while others are retained. After an initial pumping, a pH gradient shift can be used to move sample components not originally aligned with pumps to channel locations aligned with pumps. At that point, at least one pump can be used to extract and expel additional sample fluid.

The expelled sample components can be handled in a variety of ways. For example, uninteresting components can simply be discarded. Also, components can be merged for common treatment, for example, injected onto a common separation column. However, the invention also provides for discrete and parallel treatment of fluid expelled from different pumps. For example, the different sample streams can be subject to distinct separations (e.g., using plural secondary separation channels) or to discrete collection (e.g., using a moving collection medium).

A major advantage of the invention is that the second dimension of a two-dimensional analysis can be started without waiting for all sample components to exit the first separation channel serially and without relying on electro-osmotic flow for the transfer from one dimension to the next. The invention provides non-sequential, random access, to component bands. The need for a separate collection step is obviated. Several component bands can be subjected to a second dimension of analysis in parallel. Furthermore, this advantage is applicable to a wide range of first and second separation techniques, rather than being limited to electrophoretic applications. For example, an IEF separation can be followed by a polyacrylamide gel electrophoresis (PAGE) or a liquid chromatographic (preferably HPLC) separation.

Where the ejected sample components are directed at a moving media (instead of onto a separation path), the invention provides for a time-varying distribution corresponding to each nozzle. This can be useful for distinguishing components near but at slightly different distances from a nozzle.

The invention can also be used to select a particular component band for ejection, either so that it can be subjected to further analysis or to remove it from the analysis associated with the first separation channel. As an example of the latter, a strong but uninteresting band can be removed from a chromatography column to permit more sensitive detection of the remaining components. These and other features and advantage of the invention are apparent from the description below with reference to the following drawings.

### BRIEF DESCRIPTION OF THE DRAWINGS

FIG. 1 is a schematic diagram of a two-dimensional separation system in accordance with the invention.

FIG. 2 is a flow chart of the method of the invention.

FIG. 3 is a schematic diagram of a second two-dimensional separation system in accordance with the invention.

### DETAILED DESCRIPTION

A two-dimensional microfluidic chemical separation system AP1 comprises a longitudinally extending iso-electric focusing separation channel IEF and parallel transversely extending liquid chromatography channels LC1-LC6. Channels LC1-LC6 are bounded by substrate SUB, walls W20-W26, and a cover (not shown). Channel IEF is bounded by substrate SUB, walls W11 and W12, and the cover.

Longitudinally distributed along separation channel IEF are piezo-electric pumps PM1-PM6. Each pump includes a chamber CH, a nozzle NZ, and a piezo-electric drive element PZ. Each pump is in fluid communication with separation channel IEF via a respective transverse conduit CD, formed in wall W11. (Components CH, NZ, PZ, and CD are labeled for only pump PM1, but these labels apply to the identical components for the other pumps as well.) In accordance with the present invention, sample components can be transferred from channel IEF to liquid chromatography channels LC1-LC6 via pumps PM1-PM6 by activating piezo-electric drivers PZ1-PZ6. In effect, system AP1 uses inkjet technology to sample the contents of separation channel IEF.

Activating piezo-electric pump PM1 creates a pressure drop through its nozzle from the interior of its chamber to its exterior. The pressure differential causes sample liquid within the chamber to form a jet JT1 as it exits the nozzle. In flight, the ejecting liquid forms into droplets DP1 that form a plug PG1 at the head of buffer-filled liquid chromatography channel LC1. The buffer and sample in plug PG1 are urged down through channel LC1 by a vacuum pump downstream of channel LC1. Components of plug PG1 are separated as a function of their partitioning constants, as is known in the art. As they are about to elute from channel LC1, sample components are detected by detector DT1 for identification and quantification. Note that the operation for channels LC2-LC6 and detectors DT2-DT6 is nominally the same as that for channel LC1 and detector DT1.

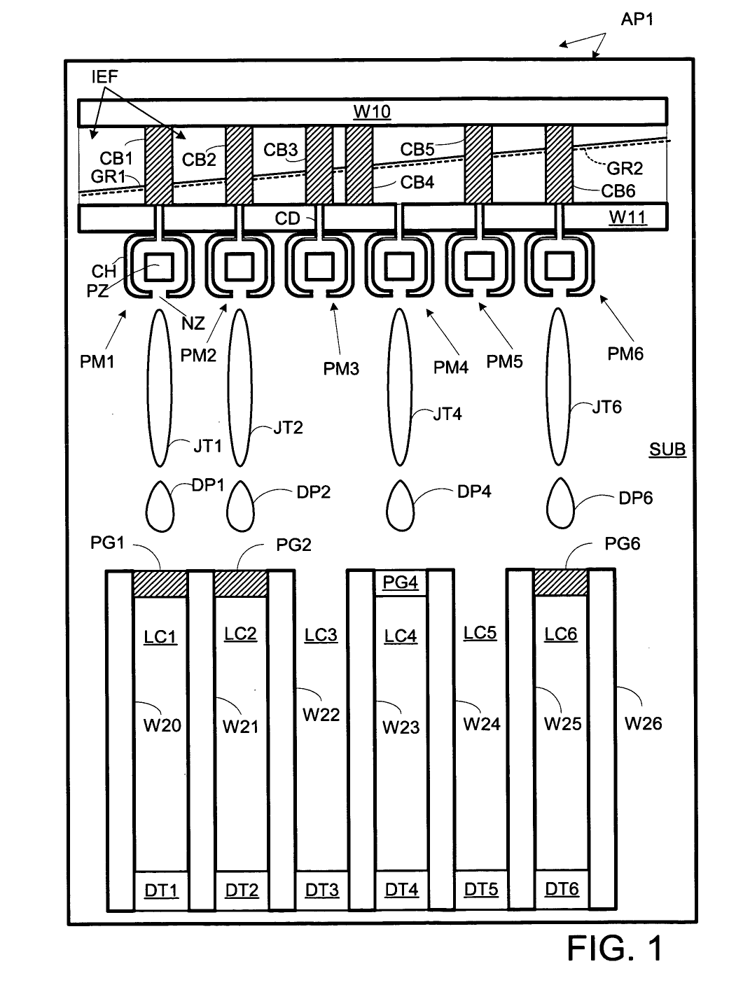

By way of example, six composite component bands CB1-CB6 are shown distributed along separation channel IEF in FIG. 1. Also, by way of example, FIG. 1 indicates that four pumps PM1, PM2, PM4 and PM6 are being activated, while two pumps PM3 and PM5 are not. Bands CB1, CB2 and CB6 are adjacent to pumps PM1, PM2 and PM6, respectively, which are activated. Accordingly, their contents are respectively ejected from channel IEF and injected onto chromatography channels LC1, LC2, and LC6 to form plugs PG1, PG2, and PG6, respectively. The sample components constituting these plugs are then separated using liquid chromatography. Pump PM4 is also activated, but no band is adjacent thereto. Accordingly, only buffer is ejected from channel IEF, thus injecting a “blank” plug PG4 onto chromatography channel LC4. Bands CB3 and CBS remain in channel IEF as they are respectively adjacent pumps PM3 and PMS, which are not activated.

Component band CB4 is not adjacent to any pump and remains within channel IEF during the activation pattern shown in FIG. 1. Once the bands of interest that are adjacent to activated pumps have been ejected, the remaining bands can be shifted to allow bands not previously adjacent to pumps to be ejected. For example, component band CB4 can be shifted so that it is adjacent to pump PM4. To this end, the buffers used to establish the pH gradient can be shifted so that the gradient moves from GR1 to position GR2. For example, a gradient can be shifted from pH 3-10 to pH 4-11. In addition, if the pH of GR1 is 3-10, ampholytes of pH 2 can be added to establish GR2 and, as a result, shift band CB3 toward pump PM4. Alternately, flow can be established along the IEF channel, and the bands can be moved along with the bulk liquid flow.

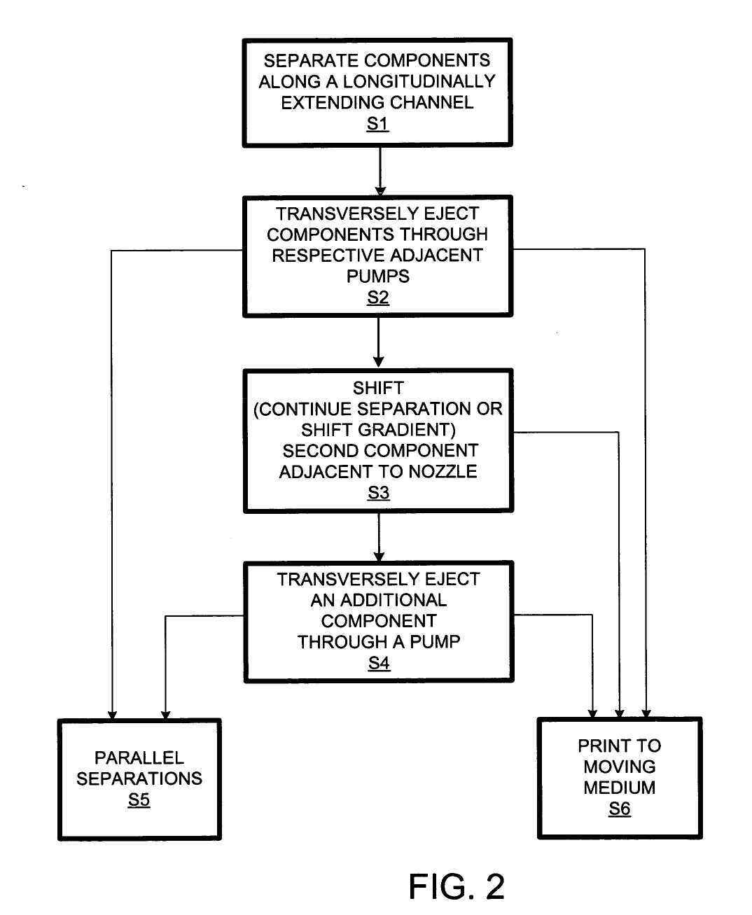

More generally, the invention provides for a chemical-analysis method M1 as flow-charted in FIG. 2. Preliminary steps involve channel and sample preparation. The invention has particular application to biological samples such as serum, CSF, semen, or synovial fluid or cell lysate samples. In the case of IEF, the entire channel can be filled with a mixture consisting of the sample of interest and an appropriate ampholyte solution. An appropriate pH gradient is then established.

At step S1, sample components are separated along a longitudinally extending channel. In the case of IEF, a series of stationary component bands is established. One band can have several sample components with similar isoelectric points.

At step S2, a sample component is ejected transversely through a nozzle. Of course, where there are several sample components in a component band, all of these are ejected at once for further analysis. Also, there can be two or more bands ejected through respective nozzles. The ejection is “transverse” if it is more transverse than longitudinal. In the case of IEF, the separation can be sampled from the nozzles without disturbing the separation profile, as long as the volume of liquid removed can be replenished from external reservoirs and enough time is allowed for the separation to reestablish. The method can also be applied to a migration-rate based separation to provide a snapshot of the separation at any given time.

If not all component bands to be ejected are adjacent to pumps in step S2, the non-aligned bands can be shifted in step S3. If the separation method is position-based, like iso-electric focusing, then the distribution can be shifted—e.g., by shifting the gradient that determines the position of each component within the channel. If the separation method is velocity based, then the separation can be continued or resumed until the second group of components are adjacent to pumps. Then they can be ejected transversely at step S4.

Transverse ejection can be used for many purposes. For example, the ejected fluid can be discarded—the purpose being to remove strongly represented but uninteresting components from the primary separation channel. Alternatively, they ejected components can be merged for further analysis—the purpose being to remove interesting components from others in primary separation channel. For example, all pumps can field a common analysis path—e.g., a single chromatography channel. For example, liquid jetted from channel IEF is collected in a collector channel; therein, they are swept into a high-pressure liquid chromatography column. The pumps can also be used in sample preparation to separate the bulk of a sample from a fraction containing the products of interest. For example, an IgG fraction (pl 6.3-7.3) can be readily separated from serum albumin (pI 4.8). The IgG fraction can then be further analyzed, either by interface to an integrated device or by manually collecting the sample.

However, the invention is put to best advantage where the ejected components are subject to parallel analysis. When the ejected components are injected into liquid chromatography (e.g., HPLC) channels, the chromatographic separation can then be performed, as indicated at step S5 of FIG. 2, after step S2, and, if the gradient shift is implemented, after step S4. The pumps can be activated at different times to control the order and timing of the introduction of sample components into the second channel.

Where an IEF separation is used as the first dimension of a multi-dimensional IEF-HPLC separation, the second dimension of separation need not be faster than the first dimension. In fact, because the IEF separation is not time dependent, the HPLC second dimension can take as long as needed. Such a system is readily suited for automated analysis. Using standard techniques such as a solvent gradient, the time dependent output of each column can be: 1) spotted onto a MALDI plate for further analysis; 2) used to create a matrix of spots on a surface for use in an array assay; 3) directed onto a surface for archiving purposes; 4) detected using an integrated flow cell and detector; or 5) analyzed via ESI mass spectrometry.

Moreover, the pumps can serve to create an electrospray directly for introduction into a mass spectrometer, or be used to direct flow into a channel for transferring to a mass spectrometer. The inkjet IEF can be combined with a multi-dimensional HPLC/MS separation by having each jetting channel feed into an integrated or attached miniature LC column and routed to an electrospray MS, preferably, via an integrated electrospray tip.

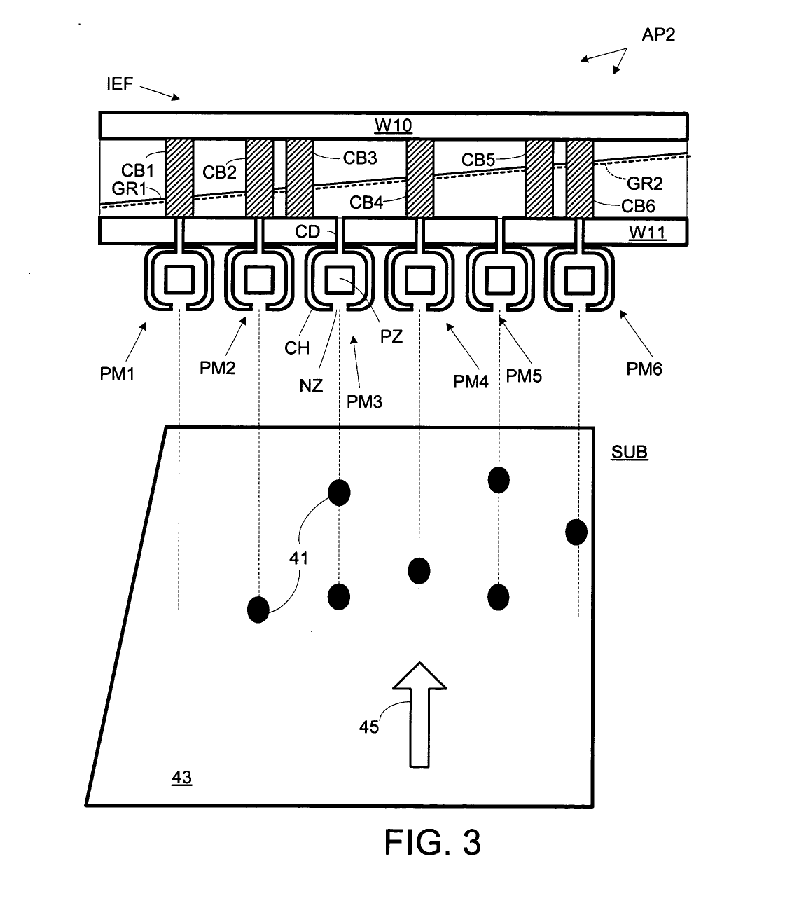

Alternatively, the pumps can also be used to deposit the separated components onto a MALDI plate, PL1 (or another type of) coated glass slide or other collection medium for further analysis, as indicated at step S6 of FIG. 2, after step S2 and, if the gradient shift is implemented, after step S4. For example, in FIG. 3, the jets deposit spots 41 on a MALDI plate 43, which is moved in direction 45 to profile the samples over time. This is particularly useful if the bands are shifted (for example with a change of pH gradient or bulk liquid flow) over time. The pumps can be used to load a standard SDS-PAGE gel, creating a more reproducible automated method for 2-D gel electrophoresis. The primary separation channel and the pumps in FIG. 3 are the same as for FIG. 1, so the references are the same. The invention further provides for continuous printing while shifting the pH gradient onto the collection medium, as indicated by the line from step S3 to step S6 in FIG. 2.

The invention provides for arranging pumps in staggered rows so that every longitudinal position (collectively subtended by the nozzles) can be addressed for sample ejection. In some embodiments, the nozzles are spaced so that pumps do not directly access intermediate longitudinal positions. In these embodiments, sample components not adjacent to a pump can be moved to adjacent nozzles and then ejected. This is straightforward in the case of separation channels that make use of differential migration rates. For separation channels, like iso-electric focusing, that make use of differential position, the separating factor can be adjusted to move the components as required for ejection. For example, in iso-electric focusing, the pH gradient can be shifted to align a component band with a nozzle by the addition of additional ampholytes.

While the drivers can be piezoelectric, the invention also provides for thermally activated jets (as in Hewlett-Packard Ink-jet printers). The electric field used to heat the sample fluid should be small enough to not appreciably disturb the electrophoresis electric field. The electrophoresis field can be shut off during actual jetting so that it does not disturb the jetting.

The invention can be used to produce microarrays comparable to those described in “Protein microarrays using liquid phase fractionation of cell lysates” by Fan Yan, Arun Sreekumar, Bharathi Laxman, Anil M. Chinnaiyan, David M. Lubman, and Timothy J. Barder, Proteomics 203, 3, 1228-1235, which is incorporated in its entirety herein. In this case, the print medium can be a solid substrate such as a MALDI plate. These and other variations upon and modifications to the described embodiments are provided for by the present invention, the scope of which is defined by the following claims.

1. A chemical-analysis system comprising:
a longitudinally extending primary separation channel; and
plural pumps, said pumps being in fluid communication with said channel via respective conduits, said conduits being longitudinally distributed along said channel, each of said conduits extending more transversely than longitudinally, said pumps having respective exit nozzles, each of said pumps being adapted for extracting fluid from said channel into said pump via its respective conduit and for expelling fluid from said pump via its respective nozzle.

2. A chemical-analysis system as recited in claim 1 further comprising means for parallel analysis of fluids expelled concurrently from respective pumps.

3. A chemical-analysis system as recited in claim 1 further comprising plural secondary separation channels, each of which is arranged to receive fluid expelled from a respective one of said pumps.

4. A chemical-analysis system as recited in claim 1 wherein each of said pumps has a piezo-electric drive element that can be used in expelling fluid.

5. A chemical-analysis system as recited in claim 1 wherein said primary separation channel employs iso-electric focusing.

6. A chemical-analysis system as recited in claim 1 wherein each of said pumps causes fluid expelled thereby to form into a jet upon exiting a respective nozzle.

7. A chemical-analysis system as recited in claim 6 further comprising means for moving a collection medium relative to said pumps for providing a two-dimensional time-vs-channel-location distribution of said sample components.

8. A chemical-analysis system as recited in claim 7 wherein said collection medium is a solid substrate and said distribution constitutes a microarray.

9. A chemical-analysis system as recited in claim 8 wherein said solid substrate is a MALDI plate.

10. A chemical-analysis method comprising:
separating sample components along a longitudinally-extending primary separation channel; and
concurrently transversely pumping fluid from at least two discrete longitudinally-separated locations along said channel so that said fluid is extracted transversely into a pump and then expelled from said pump through a nozzle.

11. A chemical-analysis method as recited in claim 10 further comprising subjecting fluids expelled from said at least two discrete longitudinally-separated locations to concurrent parallel respective analyses.

12. A chemical-analysis method as recited in claim 10 further comprising, after said pumping, separating components of fluid expelled from each of said pumps using a respective secondary separation channel.

13. A chemical-analysis method as recited in claim 10 wherein said pumping involves activating piezo-electric drive elements.

14. A chemical-analysis method as recited in claim 10 wherein said separating involves iso-electric focusing.

15. A chemical-analysis method as recited in claim 14 further comprising:
shifting a pH gradient in said primary separation channel; and
transversely pumping fluid from at least one location along said channel so that said fluid is extracted transversely into a pump and then expelled from said pump through a nozzle.

16. A chemical-analysis method as recited in claim 10 wherein, said pumping expels fluid in the form of jets.

17. A chemical-analysis method as recited in claim 16 further comprising collecting fluid expelled in the form of jets on a collection medium moving relative to said jets to yield a two-dimensional time-vs-separation-location distribution of said components.

18. A chemical-analysis method as recited in claim 17 wherein said collection medium is a solid substrate and said distribution is a microarray.

19. A chemical-analysis method as recited in claim 18 wherein said solid substrate is a MALDI plate.
